(19) United States
(12) Patent Application Publication
(10) Pub. No.: US 2009/0102278 A1
(43) Pub. Date: Apr. 23, 2009

(54) Pressure control device

(75) Inventors: Ivica Batistic, Frankfurt am Main (DE); Helmut Fennel, Bad Soden (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 10/584,793

(22) PCT Filed: Jan. 3, 2005
(86) PCT No.: PCT/EP2005/050004

§ 371 Date: Jun. 28, 2006

(30) Foreign Application Priority Data
Jan. 8, 2004 (DE) 10 2004 001 326.8
Sep. 3, 2004 (DE) 10 2004 042 647.3

(51) Int. Cl. B60T 8/36

(52) U.S. Cl. 303/113.4

(57) ABSTRACT

Disclosed is a pressure control device for varying the brake pressure in at least one wheel brake (3) of a vehicle, which includes at least one inlet valve and one outlet valve (1, 2) for the variation of the brake pressure, comprising a brake pressure channel (4) which connects a pressure fluid source (8) to the wheel brake (3) and in which the inlet valve (1) is mounted, as well as a return channel (5) which connects to the brake pressure channel (4) between the inlet valve (1) and the wheel brake (3) and in which the outlet valve is mounted (2), with the return channel (5) being connected either to a low-pressure accumulator (6) or an unpressurized supply tank. In a brake pressure control phase in which the brake pressure in the wheel brake (3) shall be increased, both the inlet valve and the outlet valve (1, 2) are opened for noise reduction, while during the time of opening of the inlet valve (1), the outlet valve (2) is opened for a length of time (t) that is shorter than the time of opening of the inlet valve (1).

### BACKGROUND OF THE INVENTION

The present invention relates to a pressure control device for varying the brake pressure in at least one wheel brake of a vehicle by a pressure control device for varying the brake pressure in at least one wheel brake of a vehicle, which includes at least one inlet valve and one outlet valve for the variation of the brake pressure, with a brake pressure channel which connects a pressure fluid source to the wheel brake and in which the inlet valve is mounted, as well as a return channel which connects to the brake pressure channel between the inlet valve and the wheel brake and in which the outlet valve is mounted, with the return channel being connected either to a low-pressure accumulator or an unpressurized supply tank.

DE 198 41 334 A1 discloses a pressure control device of this type for varying the brake pressure in several wheel brakes of a vehicle, which includes several inlet and outlet valves in a block of the control device for varying the brake pressure. In their basic position, the inlet valves provide a connection between a master cylinder (pressure fluid source) and the wheel brakes by way of several brake pressure channels in the control device block. Between the inlet valves and the wheel brakes, several return channels connect to the brake pressure channels into which the outlet valves that are closed in their basic position are mounted. The return channels connect by way of the outlet valves to a pair of low-pressure accumulators which, in a pressure reduction phase, take up the excessive pressure fluid of the wheel brakes through the opened outlet valves and convey it to a subsequent pump, which latter conveys the pressure fluid that is discharged from the wheel brakes back to the brake pressure channels upstream of the inlet valves according to the return principle.

In particular, when the inlet valves are operated, undesirable noise is produced, being due to the pressure impulses during the pressure increase phases in the wheel brakes.

In view of the above, an object of the invention is to improve a pressure control device of the type disclosed in such a way that noise is prevented from developing by means of measures as simple as possible.

### SUMMARY OF THE INVENTION

This object is achieved for a pressure control device of the indicated type by way of during a brake pressure control phase in which the brake pressure in the wheel brake (3) shall be increased, both the inlet valve and the outlet valve (1, 2) are opened, while during the time of opening of the inlet valve (1), the outlet valve (2) is opened for a length of time (t) that is shorter than the time of opening of the inlet valve (1).

The invention discloses a noise-reduced pressure control device, the noises of which initiated by actuation of the inlet valves can be eliminated due to the adept functional interaction of the inlet and outlet valves of each wheel brake.

Further features, advantages, and possible applications of the invention can be taken in the following from the description of an embodiment making reference to two accompanying drawings.

### BRIEF DESCRIPTION OF THE DRAWINGS

In the drawings:

FIG. 1 is the principal design for a pressure control device, which is arranged between a pressure fluid source and a wheel brake;

FIGS. 2a-c show diagrams relating to the duration and sequence of the operation of inlet and outlet valves in order to achieve noise-reduced pressure increase in the wheel brake.

### DETAILED DESCRIPTION OF THE DRAWINGS

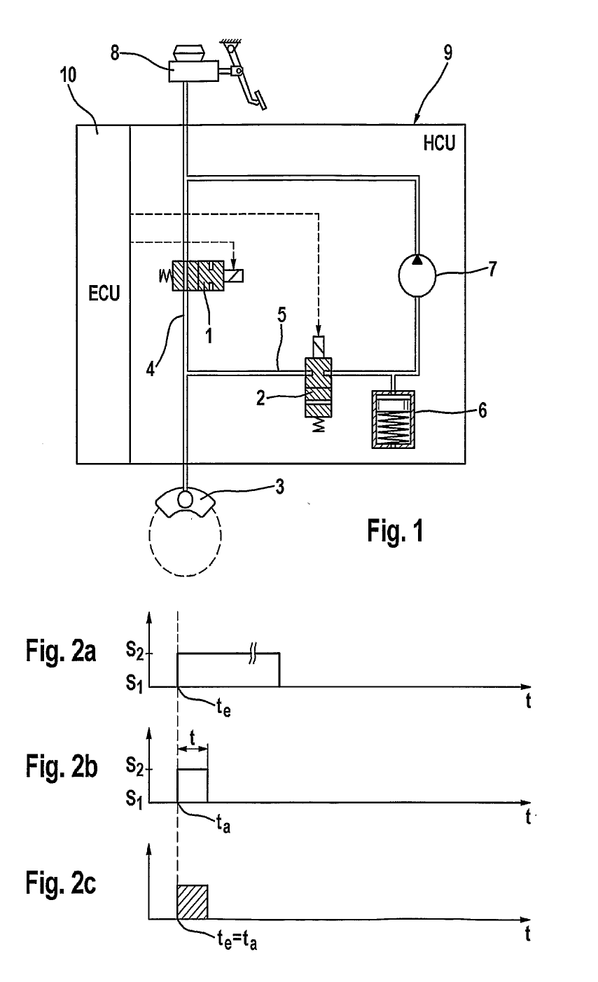

FIG. 1 illustrates the fundamental design of a pressure control device for varying the brake pressure in a wheel brake 3 of a vehicle, which includes inlet and outlet valves 1, 2 for varying the brake pressure in a control device block 9. The inlet valve 1, in its basic position, establishes a connection between a pressure fluid source 8 and the wheel brake 3 by way of a brake pressure channel 4 in the control device block 9. A return channel 5, in which the outlet valve 2 being closed in its basic position is mounted, connects to the brake pressure channel 4 between the inlet valve 1 and the wheel brake 3. By way of the outlet valve 2, the return channel 5 connects e.g. to a low-pressure accumulator 6 that is mounted in the control device block 9. This accumulator, in a pressure reduction phase, takes up the excessive pressure fluid of the wheel brake 3 through the opened outlet valve 2 and conveys the pressure fluid to a subsequent pump 7, which latter is integrated in the control device block 9, while it conveys the pressure fluid, which is discharged from the wheel brake 3, back to the brake pressure channel 4 upstream of the inlet valve 1 according to the return principle.

Both the inlet and outlet valves 1, 2 are favorably configured as a two-way/two-position directional seat valve, which is operable electromagnetically in the present embodiment. Control electronics 10 required for this purpose is favorably arranged at the control device block 9 and electrically connected to the inlet and outlet valves 1, 2.

In addition, it is pointed out that, in conformity with the number of the wheel brakes, usually further inlet and outlet valves in several valve rows are arranged in the control device block 9, with respect to which the invention that will be explained hereinbelow can also be implemented without restrictions.

For noise reduction, the invention provides that both the inlet and outlet valves 1, 2 are opened in a brake pressure control phase in which the brake pressure in the wheel brake 3 shall be increased. In the period when the inlet valve 1 is open, the outlet valve 2 is open only for a short length of time t in order to ensure the desired brake pressure increase in the wheel brake 3. The point of time of opening ta of the outlet valve 2 principally depends on the point of time of opening te of the inlet valve 1, and the point of time of opening ta of the outlet valve 2 corresponds to the point of time of opening te of the inlet valve 1, with a view to effectively avoiding a noise impulse initiated by the opening stroke of the inlet valve 1. The length of time t, in which the outlet valve 2 as well as the inlet valve 1 are opened, is limited to a few milliseconds (a maximum of 4 ms).

To compensate for the pressure fluid that is discharged from the wheel brake 3 through the outlet valve 2 during the length of time t, the period of opening of the inlet valve 1 is increased in approximation by the length of time t of the outlet valve 2.

FIGS. 2a to 2c graphically represent the previously explained operating conditions of the inlet and outlet valves in an X/Y system of coordinates. To this end, the time of opening is in each case plotted along the abscissa, while the respective switching position S1, S2 of the inlet and outlet valves 1, 2 is plotted above the ordinate, in which the inlet valve or outlet valve 1, 2, respectively, is either opened or closed.

In detail,

FIG. 2a shows a square-wave signal for a valve operating position in which the binary switching inlet valve 1, for brake pressure buildup, is opened mechanically, preferably by way of spring force or the like, for a defined duration;

FIG. 2b shows a square-wave signal for a valve switching position in which the binary switching outlet valve 2, simultaneously with the excitation of the inlet valve 1 (see FIG. 2a), is likewise excited for a certain length of time t preferably electromagnetically, piezo-electrically, or in any similar fashion, in order to remain likewise in an open switching position for a length of time t (not drawn to scale) which is considerably shorter compared to the time of opening of the inlet valve 1;

FIG. 2c shows the overlapping of valves which is essential for noise reduction, in which both the inlet valve and the outlet valve 1, 2 are simultaneously open for the short length of time t.

The invention as disclosed allows avoiding in a surprisingly simple fashion the noises which have previously been initiated due to the pressurization of the wheel brake 3 during a brake pressure control phase, because the brake fluid column which is normally compressed between the wheel brake 3, the outlet valve 2, and the master cylinder (pressure fluid source 8) is able to partly expand in the direction of the empty low-pressure accumulator 6 due to the outlet valve 2 opening during a slip-controlled pressure buildup phase. It is thus possible to effectively prevent the noises of pressure buildup, which have previously developed with each opening of the inlet valve 1 due to the propagation of the pressure buildup impulse to the incompressibly preloaded fluid column in the brake pressure channel 4.

In conclusion, it shall be noted that the invention is not limited to brake systems and pressure control devices which operate according to the return principle. The invention can likewise be used for so-called open or semi-open hydraulic circuits in which the return channel, downstream of the outlet valve, is directly connected to an open supply tank, which is usually connected to the master cylinder.

### LIST OF REFERENCE NUMERALS

1 inlet valve

2 outlet valve

3 wheel brake

4 brake pressure channel

5 return channel

6 low-pressure accumulator

7 pump

8 pressure fluid source

9 control device block

10 control electronics

1-4. (canceled)

5. A pressure control device for varying a brake pressure in at least one wheel brake of a vehicle, the device comprising:
at least one inlet valve and one outlet valve for varying the brake pressure;
a brake pressure channel which connects a pressure fluid source to the wheel brake and in which the inlet valve is mounted; and
a return channel which connects to the brake pressure channel between the inlet valve and the wheel brake and in which the outlet valve is mounted, wherein the return channel being connected either to a low-pressure accumulator or an unpressurized supply tank, wherein during a brake pressure control phase in which the brake pressure in the wheel brake is to be increased, both the inlet valve and the outlet valve are opened, and during a time of opening of the inlet valve (1), the outlet valve (2) is opened for a length of time (t) that is shorter than the time of opening of the inlet valve (1).

6. A pressure control device according to claim 5, wherein a point of time of opening of the outlet valve depends on the point of time of opening of the inlet valve, and the point of time of opening of the outlet valve corresponds to the point of time of opening of the inlet valve.

7. A pressure control device according to claim 5, wherein the length of time (t), in which the outlet valve (2) is opened, amounts to a maximum of four milliseconds.

8. A pressure control device according to claim 5, wherein the period of opening of the inlet valve is increased in approximation by the length of time of the opened outlet valve in order to compensate for pressure fluid that is discharged from the wheel brake through the opened outlet valve during the length of time.
